(19) United States
(12) Patent Application Publication
(10) Pub. No.: US 2025/0337049 A1
(43) Pub. Date: Oct. 30, 2025

(54) BATTERY PACKS, SYSTEMS, AND METHODS HAVING IMPROVED THERMAL MANAGEMENT

(71) Applicant: Urbix Inc., Mesa, AZ (US)

(72) Inventors: Palash Gangopadhyay, Chapel Hill, NC (US); Lisa J. Willis, Sanford, NC (US)

(21) Appl. No.: 18/651,421

(22) Filed: Apr. 30, 2024

(51) Int. Cl. H01M 10/6568; H01M 10/0525; H01M 10/613; H01M 10/643; H01M 50/213

(52) U.S. Cl. CPC H01M 10/6568; H01M 10/0525; H01M 10/613; H01M 10/643; H01M 50/213; H01M 2220/20

(57) ABSTRACT

Battery packs, systems, and methods of implementing improved thermal management are described. A battery pack may include a cell holder, an inlet disposed proximate to a first end of the cell holder, an outlet disposed proximate to a second end of the cell holder, and a fluid flowing between the inlet and the outlet. A first battery cell may be disposed adjacent to a second battery cell in the cell holder. A structure may be disposed in a gap between the first battery cell and the second battery cell. The structure may direct the fluid towards a first circumferential edge of the first battery cell and a second circumferential edge of the second battery cell.

### TECHNICAL FIELD

The present disclosure generally relates to thermal management of battery packs, and, more particularly, relates to improved thermal management of high-energy density lithium-ion battery packs and related systems and methods.

### BACKGROUND

Thermal management of high energy density battery packs and battery pack components is critical to ensuring optimal operation, safety, and lifespan. For example, lithium-ion cells inside of a lithium-ion battery pack should ideally be kept cool during charging and kept warm during use in colder climates. One method of cooling battery packs includes positioning one or more cold plates (e.g., water cooled cold plates) adjacent to the battery packs. Another method of cooling battery packs includes routing a coolant around lithium-ion cells in the battery packs using a system of coolant-filled channels.

### SUMMARY

Some implementations described herein relate to a battery pack. The battery pack may include a cell holder, an inlet disposed proximate to a first end of the cell holder, an outlet disposed proximate to a second end of the cell holder, and a fluid flowing between the inlet and the outlet. The battery pack may further include a first battery cell disposed in the cell holder and a second battery cell disposed adjacent to the first battery cell in the cell holder. The battery pack may further include a structure disposed in a gap between the first battery cell and the second battery cell. The structure is configured to direct the fluid towards a first circumferential edge of the first battery cell and a second circumferential edge of the second battery cell.

Some implementations described herein relate to a battery system. The battery system may include a battery pack, a pump, and a housing configured to house the battery pack and the pump. The battery pack may include a cell holder, a plurality of battery cells disposed in the cell holder, and a plurality of structures disposed in the cell holder. A structure, of the plurality of structures, may be disposed in a gap between adjacent battery cells in the plurality of battery cells, and the structure is configured to decrease a velocity of a fluid in the gap.

Some implementations described herein relate to a method of improving thermal management in a battery pack or system. The method may include providing a battery pack, the battery pack may include an inlet, an outlet, a first battery cell disposed in a cell holder, a second battery cell disposed adjacent to the first battery cell in the cell holder, and a structure disposed in a gap between the first battery cell and the second battery cell. The method may additionally include pumping a fluid through the inlet of the cell holder. The structure is configured to decrease a velocity of the fluid.

### BRIEF DESCRIPTION OF THE DRAWINGS

FIGS. 1A-1L are diagrams illustrating an example battery pack and battery pack components implementing improved thermal management and cooling.

FIGS. 2A-2H are diagrams illustrating example structures that improve the implementation of thermal management and cooling in the battery packs.

FIGS. 3A and 3B are diagrams illustrating further example battery packs and battery pack components having improved thermal management and cooling.

FIGS. 4A and 4B are diagrams illustrating further example battery packs having improved thermal management and cooling.

FIG. 5 is a diagram illustrating further example structures that improve the implementation of thermal management and cooling in the battery packs.

FIGS. 6A and 6B are diagrams illustrating further example structures that improve the implementation of thermal management and cooling in the battery packs.

FIGS. 7A and 7B are diagrams illustrating example battery pack systems having improved thermal management and cooling.

FIGS. 8A-8C are diagrams illustrating further example battery pack systems having improved thermal management and cooling.

FIGS. 9A-9E are diagrams illustrating example fluid velocity and flow data associated with battery packs and battery pack systems having improved thermal management and cooling.

FIGS. 10A-10E are diagrams illustrating example fluid velocity and flow data associated with battery packs and battery pack systems having improved thermal management and cooling.

FIG. 11 is a diagram illustrating an example method of improving thermal management in the battery packs and the battery pack systems described herein.

### DETAILED DESCRIPTION

Immersion cooling is developing as a new technology for cooling high power density electronics, such as power banks and servers, and is being explored for use in cooling battery packs and battery components. Immersion cooling employs a dielectric, electrically non-conductive fluid (i.e., also referred to as an “immersion fluid” or a “fluid”) to surround, contact, and otherwise immerse heat generating components for absorbing heat from the components. Immersion fluids have a higher thermal conductivity than air and are more efficient at removing heat. Immersion cooling has many benefits, including, but not limited to, improved sustainability, performance, and reliability.

Improved thermal management of battery packs, systems, and related methods by way of implementing immersion cooling is described herein. The battery packs, systems, and methods set forth herein utilize one or more fluid guiding structures disposed inside of a battery pack. The structures are designed to improve the dispersibility, spread ability, and uniformity of coverage associated with an immersion fluid in the battery pack. In this way, the immersion fluid may better contact individual battery cells (e.g., lithium-ion battery cells) in the pack and may, in turn, remove greater amounts of heat generated by the battery cells. The immersion fluid is pumped through the battery pack to efficiently transfer heat out of the battery pack. In this way, the need for heavy, bulky, and expensive heat sinking structures is obviated. Likewise, the need for heavy, expensive, and complex cooling structures, such as cold plates and conduits, is obviated. Notably, the battery packs, systems, and methods described herein further implement recirculation of the immersion fluid, which reduces waste and advantageously provides a sustainable approach to thermal management of battery products.

A problem associated with current devices and methods of implementing immersion cooling is a lack of adequate contact between the immersion fluid and various heat generating components inside of a device (i.e., an electrical device, a computing device, a battery pack, and/or the like). That is, the immersion fluid may not be able to flow into tight spaces and/or otherwise reach and physically contact portions of complex structures within the device, which may lead to inadequate and inefficient cooling of the device. The lack of immersion fluid reaching and adequately contacting one or more heat generating components (e.g., electrical wires, connectors, busbars, battery cells, circuitry components, and/or the like) in the device may additionally contribute to hot spots in the device, which may lead to failure and/or a shorter lifetime of the device.

Some implementations described herein employ structures that intentionally direct the immersion fluid towards the heat generating components. For example, the battery packs and systems described herein advantageously employ fluid-directing structures strategically positioned within spaces or gaps between adjacent lithium-ion cells to slow a velocity of the immersion fluid in the gaps and additionally direct the immersion fluid out of the gaps and towards the lithium-ion cells. As a result, the immersion fluid makes better contact with the lithium-ion cells (or other heat generating components), and more effectively transfers heat away from the lithium-ion cells (or other heat generating components). In this way, the battery packs and systems described herein may run cooler under loads while charging and discharging.

Further, the fluid-directing structures descried herein may advantageously magnify the effects of immersion cooling in high-energy density battery packs, by way of implementing a greater spread of a dielectric immersion fluid in the battery packs to manage heat more efficiently in the battery packs. This structures may be printed (e.g., 3D printed), or otherwise manufactured, and be provided within a battery pack to enhance fluid contact with battery cells and improve flowability, thereby maximizing heat removal and, likewise, reducing the need for traditional, bulkier cooling systems.

The use of the structures described herein solves additional problems associated with existing immersion cooling systems, which are also not popular in the market due to the poor cost-benefit ratio. The effectiveness of a cooling process depends heavily on the ability of a fluid to reach and maintain contact with all components. Structurally manipulating the flow of fluid within tight spaces by way of strategic placement and design of the physical structures described herein advantageously guides the cooling fluid in specific ways, for example, by guiding the fluid towards internal or external surfaces of various heat-generating components.

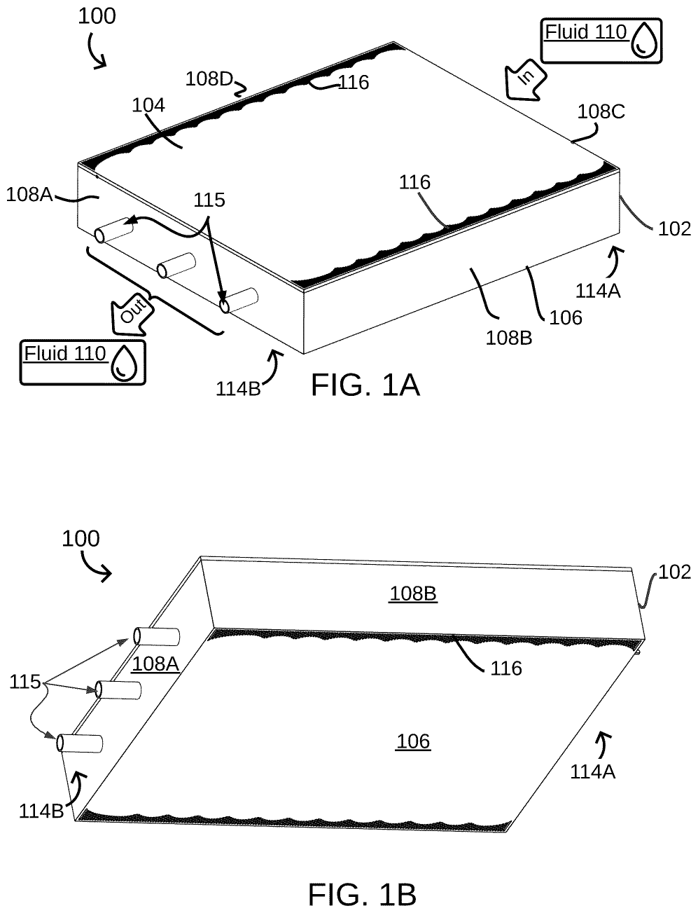

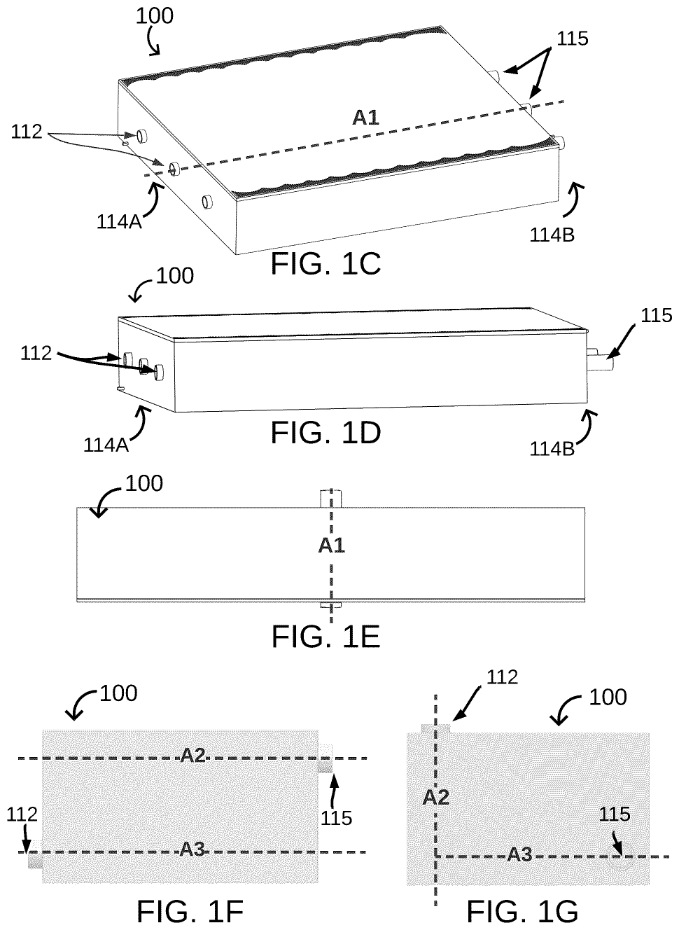

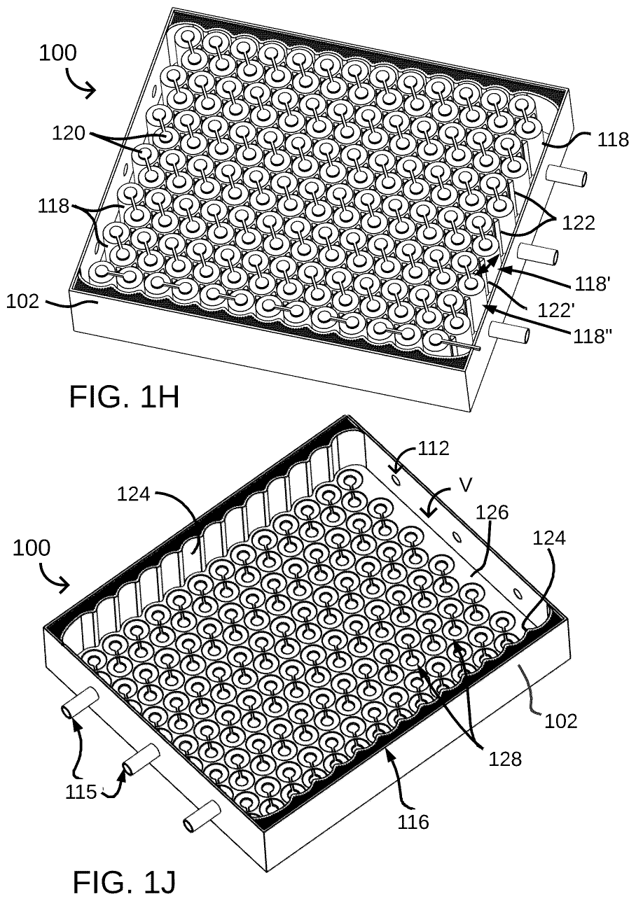

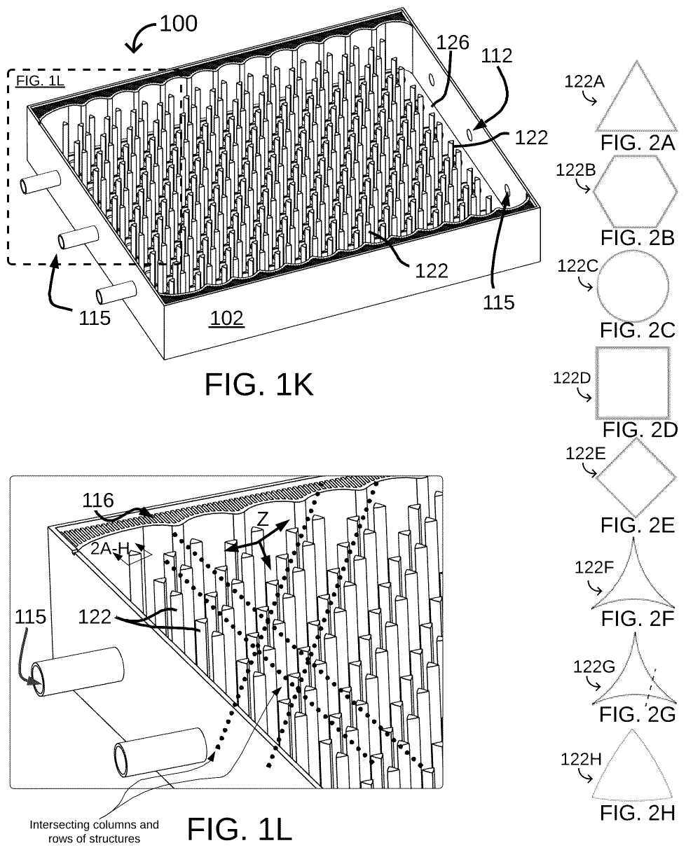

FIGS. 1A-1L are diagrams illustrating a battery pack 100 and battery pack components implementing improved thermal management and cooling. In some implementations, the battery pack 100 includes a cell holder 102 and a cover 104 disposed on and/or over the cell holder 102. The cover 104 may be attached to the cell holder 102 using any known method (e.g., via a friction fit attachment, welding, gluing, tacking, and/or the like) to cover and/or seal the contents of the cell holder 102. The cover 104 forms a first surface of the battery pack 100. A second surface 106 of the battery pack 100 and the cell holder 102, also referred to as a lower surface, opposes the first surface (i.e., opposite the cover 104). The second surface 106 may form a base of the battery pack 100.

The cell holder 102 may further include or comprise a plurality of walls extending between the first surface and the second surface 106, for example, the cell holder 102 may include a first sidewall 108A, a second sidewall 108B, a third sidewall 108C, and a fourth sidewall 108D. The cell holder 102 may comprise or be formed of a metal (e.g., a transitional metal, a metalloid, etc.), a metal alloy, or a plastic material (e.g., a polymer, a copolymer, etc.). For example, and in some implementations, the cell holder 102 comprises nickel (Ni), aluminum (Al), chromium (Cr), iron (Fe), cobalt (Co), silver (Ag), and any alloys or compositions thereof. In further implementations, the cell holder 102 is formed from steel, such as a stainless steel (e.g., a ferritic stainless steel, an austenitic stainless steel, etc.), a carbon steel, an alloy steel, or a tool steel. In yet further implementations, the cell holder 102 is formed from a copolymer comprising polypropylene (PP) and polyethylene (PE).

The cell holder 102 defines a volume V (FIG. 1J) between a top of the lower surface 106 (i.e., which also forms a base and floor of the cell holder 102), the cover 104, and inner surfaces of sidewalls 108A-108D. One or more rechargeable battery cells 118 (FIG. 1H), electrical components (e.g., busbars, connectors, wires, battery terminals, and/or the like), and a volume or amount of an immersion fluid 110 (i.e., also referred to as a “fluid”) may be disposed within the volume V of the cell holder 102. The immersion fluid 110 is configured to surround and fully immerse the battery cells 118 and electrical components inside of the battery pack 100 to remove heat from the battery cells 118 and electrical components during charging and/or discharging, as the individual battery cells 118 and electrical components may heat up when exposed to electrical current and power loads. As described further, the immersion fluid 110 may continuously flow through the battery pack 100 so that heat may continuously be transported out of the battery pack 100 as the battery pack 100 is charging and/or discharging. In this way, heat removal is optimized and the battery pack 100 may run cooler when in use.

In some implementations, the battery pack 100 has a volume V of between approximately 2,500 cm³ and 7,500 cm³. For example, battery pack 100 may have a volume V of approximately 5,200 cm³. Battery packs 100 having volumes V greater than or less than 2,500 cm³ and 7,500 cm³, respectively, are contemplated (e.g., battery pack 100 may have a volume V that is greater than 1,000 cm³, greater than 5,000 cm³, greater than 10,000 cm³, greater than 20,000 cm³, greater than 40,000 cm³, greater than 80,000 cm³, etc.). Multiple battery packs 100 may be electrically connected (e.g., in series, in parallel, or in a combination of series and parallel) to form a single, larger battery pack or battery pack module, in some cases.

Referring collectively to FIGS. 1A-1D, at least one inlet 112 (FIGS. 1C-1D) is disposed proximate to a first end 114A of the cell holder 102 and/or the battery pack 100 and at least one outlet 115 (FIGS. 1A-1B) is disposed proximate to a second end 114B of the cell holder 102 and/or the battery pack 100. In some implementations, only one inlet 112 and one outlet 115 are provided in the cell holder 102 and the battery pack 100, in other implementations a plurality of inlets 112 (e.g., two inlets, three inlets, four inlets, etc.) and a plurality of outlets 115 (e.g., two outlets, three outlets, four outlets, etc.) are provided in the cell holder 102 and the battery pack 100.

In some implementations, the inlets 112 and the outlets include conduits with openings having a diameter of approximately 10 mm, approximately 15 mm, or a diameter ranging between approximately 8 mm and 20 mm (e.g., +/−1 mm). In some implementations, the inlets 112 and the outlets 115 include a length and protrude or project a distance away from the battery pack 100. For example, the inlets 112 may include a length of between about 1 mm and 10 mm (e.g., +/−10 percent) and the outlets 115 may include a length of between about 20 mm and 40 mm (e.g., +/−10 percent). In some cases, the inlets 112 are approximately 5 mm in length and the outlets 115 are approximately 30 mm in length. Inlets 112 and outlets 115 having any desired diameter and length are contemplated.

A desired amount or volume of immersion fluid 110 is configured to flow between the inlets 112 and outlets 115 for continuous heat dissipation and improved thermal management in the battery pack 100. As the immersion fluid 110 flows over and around various heat generating components (e.g., the lithium-ion cells, the electrical components, and/or the like) the immersion fluid 110 absorbs, pulls, or otherwise draws heat away from the heat generating components and then moves the heat out of the battery pack 100 as the now heated fluid flows out of the battery pack 100 via the one or more outlets 115. The immersion fluid 110 may optionally be cooled prior to re-entering the inlets and the immersion fluid 110 may continuously recirculate through the battery pack 100, in some instances.

A heatsink 116 may optionally be formed on, or otherwise disposed on or over, portions of the battery pack 100. The heatsink 116 may include one or more fins configured to dissipate heat from the battery pack 100. The heatsink 116 may comprise a metal or other thermally conductive material, and in some cases, the heatsink 116 may comprise a heat sinking body of material (e.g., a heat sinking foam, a heat sinking layer of metal, a heat sinking layer of thermally conductive plastic material, and/or the like). The heatsink 116 may be disposed around one or more outermost edges of the cell holder 102 and/or the battery pack 100 so that heat may further dissipate into the ambient air outside of the battery pack 100. In this way, the battery pack 100 may run cooler when placed under a load.

The volume of immersion fluid 110 entering the battery pack 100 may depend on the volume V of the battery pack 100, the number of battery cells in the battery pack 100, and/or the like. The immersion fluid 110 may flow at a desired rate or velocity through the battery pack 100 to effectively dissipate heat from the battery pack 100. In some implementations, the immersion fluid 110 flows into the battery pack 100 at a velocity of around 10 meters/second (m/s). However, flowing immersion fluid 110 through the battery pack 100 at any velocity greater than 0.01 m/s is contemplated.

Example immersion fluids 110 and chemical and physical properties associated therewith are provided in Table 1 below. The use of any type of immersion fluid 110 in the battery pack 100 is contemplated. For example, use of a liquid dielectric immersion fluid 110 that is a non-electrically conductive or exhibits a reduced electrical conductivity (i.e., <100 μS/cm) is contemplated. Immersion fluids 110 may also exhibit a thermal conductivity of greater than 0.05 W/mk at 20° C. In some implementations, a biodegradable immersion fluid 110 is used in the battery pack 100, thus providing a battery system with minimal environmental impact.

TABLE 1

| | | SPE- | THERMAL | |
|---|---|---|---|---|
| | DEN- | CIFIC | CONDUC- | KINEMATIC |
| | SITY | HEAT | TIVITY | VISCOSITY |
| FLUID | (kg/m³) | (J/kg K) | W/mK | (kg/ms) |
| FREECOR ® EV | 1066 | 3300 | 0.42 | 0.004 |
| Milli 10 | | | | |
| MIVOLT ® DF7 | 916 | 1907 | 0.13 | 0.015 |
| MIVOLT ® DFK | 968 | 1902 | 0.15 | 0.073 |
| 3M FLUORINERT ™ | 1680 | 1100 | 0.06 | 0.001 (cSt) |
| FC-72 (these | | | | |
| values @25° C.) | | | | |

* All values @ 20° C. unless otherwise specified.

Referring to FIG. 1C and, in some implementations, the one or more inlets 112 may be disposed along a same axis A1 as the one or more outlets 115. The axis A1 may be horizontally aligned or vertically aligned respective to the battery pack 100. For example, as shown in FIG. 1C, the axis A1 is horizontally aligned respective to the battery pack 100 and disposed along an elongate axis (i.e., along a length of the battery pack 100), which is greater in magnitude than a vertical axis (i.e., a height of the battery pack 100). As shown in FIG. 1E, the inlet 112 and the outlet 115 may be respectively formed in the cover 104 and the second surface 106 that opposes the cover 104, so that the inlet 112 and the outlet 115 are each disposed and open externally along axis A1. In this case, axis A1 may be vertically aligned respective to the battery pack 100 and disposed along a smallest dimension of the pack (i.e., the height of the pack).

Referring now to FIGS. 1F and 1G, and in some cases, the inlet 112 and the outlet 115 may be disposed along different axes. For example, as FIG. 1F illustrates, an inlet axis A2 may be parallel with an outlet axis A3. Alternatively, as FIG. 1G illustrates, the inlet axis A2 may be perpendicular to the outlet axis A3. As persons having skill in the art will appreciate, any desired location and/or arrangement of the inlet 112 and the outlet 115 is contemplated, as may be determined by the size of the battery pack 100, the shape of the battery pack 100, and/or a desired velocity of immersion fluid 110 flowing through the battery pack 100.

FIGS. 1H and 1J are diagrams illustrating various example internal components of the battery pack 100, as the cover 104 is not shown in these diagrams. Referring to FIG. 1H, a plurality of battery cells 118 is disposed in the cell holder 102 and the battery pack 100. In some implementations, the battery cells 118 are rechargeable battery cells having a cylindrical shape and body style. The use of any type of rechargeable battery cells in the battery pack 100 is contemplated. In some cases, the battery cells 118 are rechargeable lithium-ion battery cells having a 3.7 maximum charging voltage and a capacity of 4 Ah.

The battery cells 118 may be electrically connected, meaning the negative and positive electrodes of respective battery cells 118 may be connected in series or in parallel between corresponding common terminals. Battery cell terminals (i.e., the + and − ends) of the respective battery cells 118 may be electrically connected by way of electrically conductive terminal connectors 120.

One or more busbars (not shown) may be disposed on or over the battery cells 118 and/or terminal connectors 120 to transmit electrical current to and from the battery cells 118 during charging and discharging. In some implementations, two busbars (i.e., one for connecting to battery cell anodes and one for connecting to battery cell cathodes) are disposed on opposing sides and opposing terminals of the battery cells 118 for passing current to and from the battery cells 118. For example, a first busbar (not shown) may be disposed along a lower floor of the cell holder 102 that supports the battery cells 118 and a second busbar (not shown) may be disposed along an upper surface of the cell holder 102, for example, the second busbar may be disposed between the terminal connectors 120 and the cover 104 (FIG. 1A). In some implementations, the battery pack 100 is intended to be used in an electric vehicle (EV) and may include anywhere from 10 to 200 individual battery cells 118 to achieve a desired overall voltage and current capacity. As an example, the battery pack 100 may include 169 individual battery cells 118. As persons skilled in the art will appreciate, battery pack 100 may include any desired quantity of battery cells 118 for obtaining a desired output voltage and capacity. As persons skilled in the art will further appreciate, multiple battery packs 100 (i.e., also referred to as battery pack modules) may be electrically connected (e.g., via electrical connectors such as busbars, wires, and/or the like) for use in an EV.

Still referring to FIG. 1H, a plurality of structures 122 may be intermixed with the plurality of battery cells 118. In some implementations, the battery cells 118 and structures 112 form an array or matrix, in which the structures 122 and battery cells 118 are arranged in several rows and/or columns. The structures 122 may be disposed in gaps between the battery cells 118. In this way, the structures advantageously promote the spread of immersion fluid 110 (FIG. 1A) in the gaps and intentionally aim or direct the immersion fluid 110 away from the gaps and towards the heat generating components, including the battery cells 118. The structures 122 may be vertically disposed in the battery pack (i.e., parallel to a height of the battery pack) or horizontally disposed in the battery pack 100 (i.e., perpendicular to a height of the battery pack). In some cases, the structures are angled respective to the height of the battery pack.

As FIG. 1H illustrates, at least one structure 122′ is provided in a gap between a first battery cell 118′ and a second battery cell 118″. The at least one structure 122′ is configured to slow a velocity of the immersion fluid 110 in the gap and direct the immersion fluid 110 towards a first circumferential edge of the first battery cell 118′ and a second circumferential edge of the second battery cell 118″, as indicated by the bi-directional arrow in FIG. 1H. In this way, the immersion fluid 110 may better contact the battery cells 118 and, thus, improve heat absorption to allow the battery pack 100 to run cooler during charging and discharging. The structures 122 may guide the immersion fluid 110 in multiple directions, advantageously towards outer/external surfaces of adjacent battery cells and/or internal or external surfaces of various other types of heat generating components.

Referring now to FIG. 1J, the cell holder 102 and the battery pack 100 define a volume V between inner surfaces 124 of cell holder 102, cover 104 (FIG. 1A), and a floor or lower support surface 126 of the cell holder. The inner surfaces 124 of the cell holder 102 may be disposed adjacent to and/or abut the heatsinks 116, in some implementations. The support surface 126 of the cell holder 102 may include one or more pockets or recesses 128 defined therein, which assist in retaining, supporting, and/or holding the battery cells 118 (FIG. 1H) and terminal connectors 120 (FIG. 1H) in the battery pack 100. A busbar, not shown, may electrically connect to lowermost terminal connectors 120 disposed in the recesses 128 for electrically charging and discharging the battery cells 118 as the battery cells are seated in the recesses 128.

FIGS. 1K and 1L are diagrams illustrating example structures 122 in the battery pack 100 and cell holder 102. For illustration purposes only, the cover 104 and battery cells 118 are not shown in FIGS. 1K and 1L. In some implementations, a plurality of columnar structures, or pillar shaped structures 122 (e.g., also referred to as “pillars” or “pillar-like structures”) may extend from the support surface 126 of the cell holder 102. The structures 122 may be integrally formed with the support surface 126 and the cell holder 102, such that the structures 122, the support surface 126, and the cell holder 102 may each be formed from the same material. That is, the structures 122, support surface 126, and cell holder 102 may be formed from a metal, a metal alloy, or a plastic material as described above (e.g., a copolymer of PP/PE, a steel, a metal or a metal alloy comprising Ni, Cr, Al, Fe, Ag, Co, and/or the like). Notably, in some cases the cell holder 102 and the structures 122 may be formed by way of 3D printing as a single unit. In this way, ease of manufacture is advantageously simplified and improved. In some implementations, the structures 122 are arranged in columns and/or rows and may include different sectional shapes as described further below.

The structures 122 are designed to intentionally block immersion fluid from entering portions of the gaps between adjacent battery cells 118 and, rather, guide or direct the immersion fluid 110 (FIG. 1A) towards battery cells 118 (FIG. 1H), and surfaces thereof, to better cool the battery cells 118 and, thus, the entire battery pack 100. The structures 122 may inhibit the immersion fluid 110 from flowing too quickly between the inlets 112 and the outlets 115. As fluid naturally takes a path of least resistance, without the structures 122 in place, the immersion fluid 110 may flow too quickly through the gaps between the inlets 112 and the outlets 115 and fail to adequately contact the battery cells 118. Providing structures 122 in the gaps between adjacent battery cells 118 advantageously decreases or slows the flow of immersion fluid 110 through the cell holder 102 to better wet/contact the battery cells 118. Additionally, the structures 122 may assist in retaining the battery cells 118 during transport of the battery pack 100.

In some cases, an amount of immersion fluid 110 needed to adequately cool the battery pack 100 may be reduced, thus, advantageously resulting in a cost savings per unit. For example, the structures 122 may occupy a portion of the volume V within the battery pack 100 that would otherwise be occupied by fluid 110. For example, where structures 122 are not used in battery pack 100, a volume of immersion fluid in the pack is about 1200 cm³ (+/−5 percent). Where structures 122 are provided in battery pack 100, such structures may occupy about 1050 cm³ (e.g., +/−5 percent) of the battery volume V. In this way, providing structures 122 may reduce an amount of immersion fluid 110 needed per battery pack 100 by about 8 to 15 percent (+/−1 percent).

Referring to FIG. 1L, and as noted above, the pillars or structures 122 projecting from the support surface 126 of the cell holder 102 are configured to advantageously block or obstruct the flow of immersion fluid in gaps between the battery cells 118 (FIG. 1H) and redirect the immersion fluid towards the battery cells 118, as indicated by the directional arrows Z to dissipate heat more readily from the battery cells 118 and move the heat out of the battery pack 100. As indicated by the broken lines, the structures 122 may be disposed in an array of linear rows and/or linear columns. The rows and/or columns of structures 122 may intersect at acute and obtuse angles to improve the distribution of immersion fluid 110 (FIG. 1A) in the cell holder 102 and the battery pack 100. The structures 122 may restrict the velocity of the immersion fluid 110 flowing through the pack, which allows the immersion fluid to better contact the battery cells 118. Notably, the structures 122 are configured to cause or force the immersion fluid to flow against and contact the battery cells 118 and other electrical components in the battery pack 100. In this way, hot spots in the battery pack 100 may be minimized and/or mitigated.

As indicated above, FIGS. 1A-1L are provided as examples. Other examples may differ from what is described with regard to FIGS. 1A-1L.

FIGS. 2A-2H illustrate example structures 122 (FIG. 1L) that improve the implementation of thermal management and cooling in the battery pack 100. FIGS. 2A-2H illustrate various example sectional views of the structures 122 as taken along the line 2A-2H in FIG. 1L.

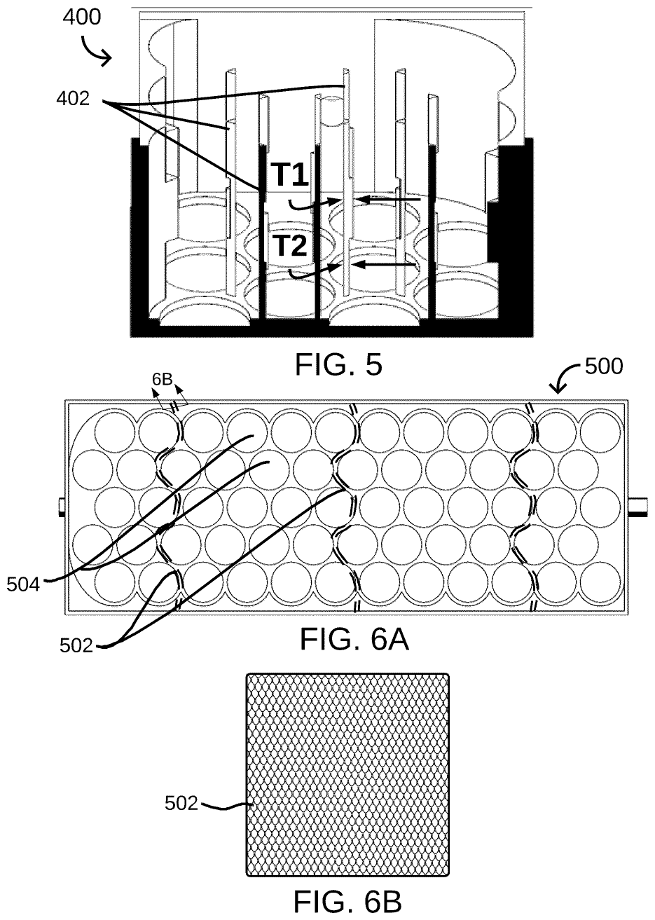

As shown in FIG. 2A, the structures 122 (FIG. 1L) may include a triangular cross-sectional shape 122A. In some implementations, the structures 122 may include a hexagonal cross-sectional shape 122B, a circular cross-sectional shape 122C, a square cross-sectional shape 122D, or a diamond cross-sectional shape 122E, as shown in FIGS. 2B-2E. In further implementations, the structures 122 may include a triangular cross-sectional structure having curved sides (e.g., curved inwardly towards a center of the triangle or curved outwardly away from a center of the triangle). For example, and as FIGS. 2F and 2G illustrate, the structures 122 may include hyperbolic triangular cross-sectional shapes 122F and 122G (i.e., also referred to as circular arc triangles) that may curve inwards to various degrees. The broken line in FIG. 2G illustrates how a sectional shape of a structure 122G may vary along a length of the structure (e.g., FIG. 2G is illustrative of a sectional view along a length of a structure having a variable thickness, such as structure 402 shown in FIG. 5). As FIG. 2H illustrates, the structures 122 may include a cross-sectional shape in the form of a Reuleaux triangle 122H. Any size (e.g., length, width, diameter/thickness, etc.) and/or cross-sectional shape of structures 122 is contemplated. Structures having assorted sizes and/or sectional shapes may be used together in a same battery pack 100. Alternatively, a battery pack 100 may use only structures that are of a same size and cross-sectional shape.

In some implementations, the structures 122 may comprise a diameter of between approximately 1 mm and 5 mm (+/−10 percent). For example, structures 122 having a circular cross-sectional shape and a diameter of approximately 2 mm are contemplated. As another example, structures 122 having a hexagonal cross-sectional shape and a diameter of approximately 2.5 mm are contemplated. Further, structures 122 having a triangular cross-sectional shape and a diameter of approximately 2.8 mm are contemplated. Such structures 122 having the cross-sectional shapes 122A-122H described herein are configured to occupy the gaps and spaces between adjacent battery cells 118 (FIG. 1H) and force the immersion fluid to contact a larger surface area of adjacent battery cells 118. Structures having diameters less than 1 mm and greater than 5 mm are contemplated.

As indicated above, FIGS. 2A-2H are provided as examples. Other examples may differ from what is described with regard to FIGS. 2A-2H.

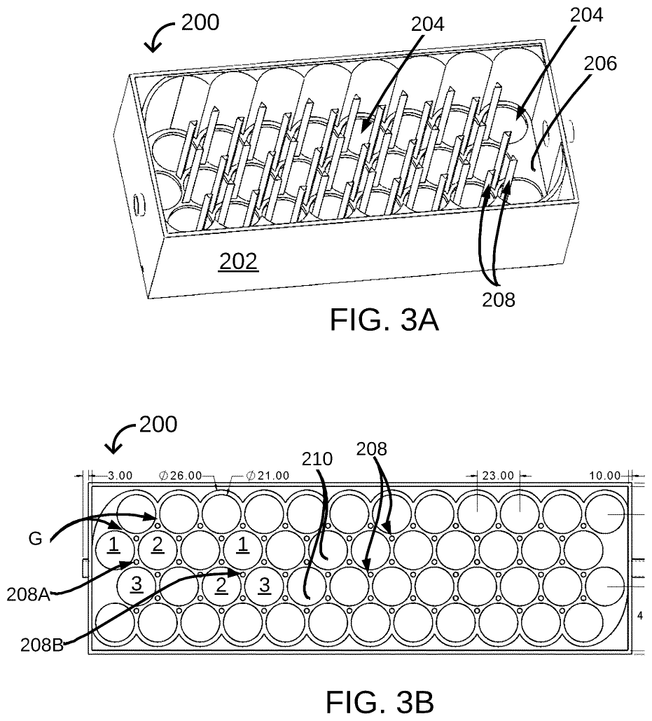

FIGS. 3A and 3B are diagrams illustrating a further example battery pack 200 and battery pack components having improved thermal management. Referring to FIG. 3A, the battery pack 200 comprises a cell holder 202 configured to hold 24 battery cells (not shown in this view, see battery cells 210 in FIG. 3B). The battery cells may be supported by one or more pockets or recesses 204 formed in a support surface 206 of the battery pack 200. A plurality of elongated structures 208 are disposed around each of the battery cells in the battery pack 200.

As FIG. 3B illustrates, a plurality of battery cells 210 may be disposed in the cell holder 202 of the battery pack 200. The plurality of battery cells 210 may be spatially intermingled and intermixed with a plurality of structures 208. One or more gaps G may be disposed between adjacent battery cells in the plurality of battery cells 210. The plurality of structures 208 may be provided in the gaps G. In some implementations, at least some of the battery cells 210 are surrounded by a quantity of three structures 208. As FIG. 3B further illustrates, at least some of the battery cells 210 are surrounded by six structures 208. As an example, three or more structures 208 may be disposed around a majority of the battery cells 210 in a row of battery cells (e.g., a row of battery cells may include two battery cells 210, three battery cells 210, four battery cells 210, etc.). As many as eight, ten, twelve, thirteen, twenty, or more than twenty battery cells 210 may be included in a single row of battery cells. Still referring to FIG. 3B and in some implementations, three or more structures 208 may be disposed around each battery cell 210 in the row of battery cells 210.

Notably, as FIG. 3B further illustrates, each structure 208 may be surrounded by at least three battery cells 210. For example, a first structure 208A is surrounded by three battery cells labeled as 1, 2, and 3. Likewise, a second structure 208B is surrounded by three battery cells labeled 1, 2, and 3. In this way, each of the first and second structures 208A and 208B may direct immersion fluid out of and/or away from the gaps G and towards at least three battery cells. In this way, the spatial arrangement of structures 208 increases the spread and dispersion of immersion fluid in the battery pack 200, while helping to cool the battery pack 200.

As noted above, FIGS. 3A and 3B are provided as examples. Other examples may differ from what is described with regard to FIGS. 3A and 3B.

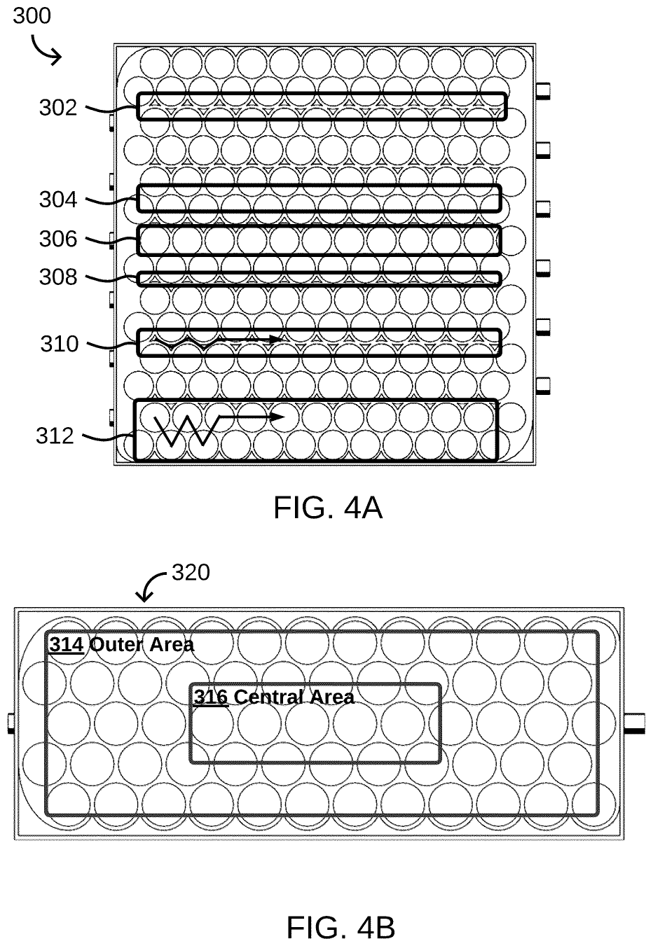

FIGS. 4A and 4B are diagrams illustrating further example battery packs having improved thermal management. As FIG. 4A illustrates, a battery pack 300 includes a plurality of structures and a plurality of battery cells arranged in rows. As depicted in block 302, a row of structures is disposed between two adjacent rows of battery cells. As depicted in block 304, in some cases, adjacent rows of adjacent battery cells may be disposed immediately next to each other without an intervening structure or row of structures. As depicted by block 306, the battery cells may be arranged in a straight arrangement or line, thus, forming a straight row of battery cells. As depicted by block 308, the structures may be arranged in a straight line or arrangement, thus, forming a straight row of structures. As depicted by block 310, the structures may be arranged in a zigzag pattern or arrangement, in which adjacent structures in a row alternate above and below a straight line. Finally, as depicted by block 312, the battery cells may be arranged in a zigzag pattern or arrangement, in which adjacent battery cells in a row alternate above and below a straight line. In this way, a tighter more compact packing of the battery cells and structures may be achieved.

FIG. 4B illustrates different areas of a battery pack 320. In some implementations, an outer area 314 of the battery pack 320 may be devoid of structures while a central area 316 of the battery pack 320 may include structures. Similarly, in some cases, the outer area 314 of the battery pack 320 may include structures while the central area 316 of the battery pack 320 may be devoid of structures. In this way, material may be conserved and the weight of the battery pack 320 may be reduced.

FIGS. 4A and 4B are provided as examples. Other examples may differ from what is described with regard to FIGS. 4A and 4B.

FIG. 5 is a diagram illustrating further example structures 402 that improve the implementation of immersion fluid cooling in battery packs. As FIG. 5 illustrates, a battery pack 400 may include the or more structures 402 disposed therein. The structures 402 may comprise a length, and a diameter or thickness of the structures 402 may vary along the length. That is, the structures 402 may comprise a first thickness T1 and a second thickness T2 that is different than the first thickness T1. The first thickness T1 may be greater in magnitude than the second thickness T2. Additionally, the structures 402 may comprise one or more cutouts, notches, and/or apertures formed therein. Similarly, the structures 402 may taper along the length.

FIG. 5 is provided as an example. Other examples may differ from what is described with regard to FIG. 5.

FIGS. 6A and 6B are diagrams illustrating further example structures 502 that improve the implementation of immersion fluid cooling in battery packs. Referring to FIG. 6A, a battery pack 500 is provided. The battery pack 500 may include the one or more structures 502 and one or more battery cells 504 disposed therein. The structures 502 may be disposed between adjacent battery cells 504. In some implementations, as shown in FIG. 6B (taken along line 6B-6B in FIG. 6A), the structures 502 are formed from and/or comprise a mesh structure or material. The mesh structure may improve dispersion and spreading of an immersion fluid in the battery pack 500 as the immersion fluid flows through the battery pack 500. In some implementations, the mesh structure causes the immersion fluid to better contact the battery cells 504. The mesh structure may be formed simultaneously with the cell holder, e.g., via 3D printing, in some cases. In other cases, the mesh structure is formed separately from the cell holder and placed into the cell holder after manufacture of the cell holder, either prior to or after placement of the battery cells in the cell holder. In some cases, the mesh structure may include a plurality or network of horizontal and vertically disposed structures, which may be positioned inside of the battery pack and between the battery cells.

FIGS. 6A and 6B are provided as examples. Other examples may differ from what is described with regard to FIGS. 6A and 6B.

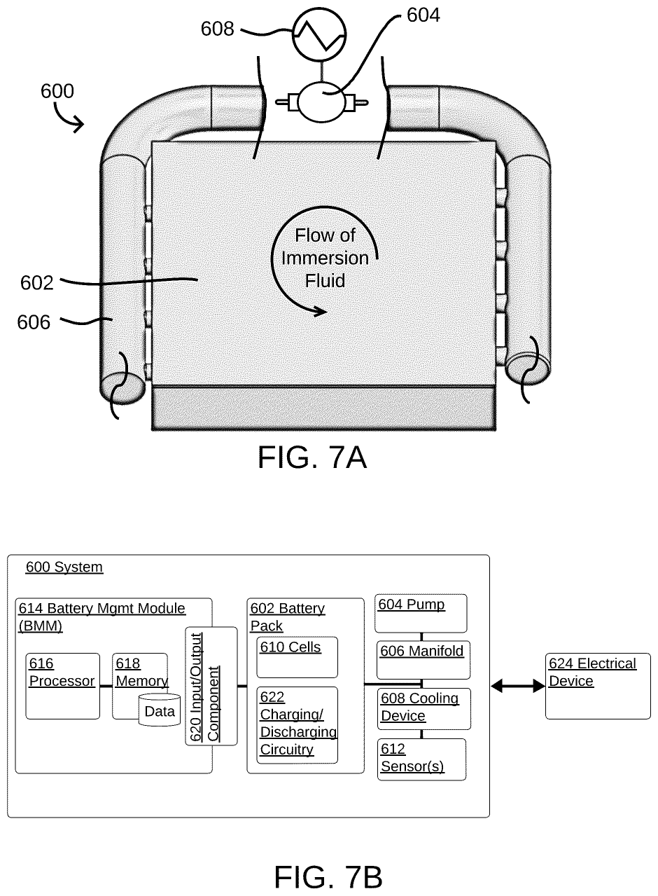

FIGS. 7A and 7B are diagrams illustrating example a battery pack system 600 having improved thermal management and cooling. The system 600 comprises a battery pack 602 having a plurality of inlets and a plurality of outlets. A pump 604 is configured to continuously pump a fluid (i.e., an immersion fluid) through the battery pack 602 via the inlets and outlets. Notably, the fluid is recirculated through the battery pack 602 as it leaves the outlets. The fluid is pumped at a desired rate or velocity through the battery pack 602. The pump 604 is configured to transfer the fluid to the battery pack 602 by way of a manifold 606, which is connected to the inlets and outlets of the battery pack 602. The manifold 606 may include a conduit, or a series of interconnected conduits, for recirculating the fluid through the pump 604 and the battery pack 602. In some implementations, the fluid may be cooled before it reenters the battery pack 602. In some implementations, the fluid may be cooled as it flows through the manifold 606. For example, the fluid may be cooled by way of a cooling device 608, such as a cooling jacket wrapped around the manifold 606, a heat exchanger, and/or the like.

FIG. 7B is a block diagram of system 600. The system 600 may include the battery pack 602 having one or more battery cells 610 and charging and discharging circuitry 622, pump 604, manifold 606, cooling device 608, one or more sensors 612, and a battery management module (BMM) 614. The BMM 614 may control aspects of system 600, such as the speed at which fluid pumps through the system 600, the temperature of the system, the charging and/or discharging rates of the battery pack 602, and/or the like. In some implementations, the sensors 612 provide data to BMM 614 (e.g., velocity data, temperature data, charging data, battery capacity information, battery discharging data, etc.) for use in controlling system 600. As shown in FIG. 7B, the BMM 614 may include a processor 616, a memory 618, and a communication interface, such as an input/output component 620. The BMM 614 may include a wired and/or wireless controller.

The processor 616 may include a central processing unit, a microprocessor, a controller, a microcontroller (MCU) or a microchip, a digital signal processor, a field-programmable gate array, an application-specific integrated circuit, and/or another type of processing component. The processor 616 may be implemented in hardware, firmware, or a combination of hardware and software. In some implementations, the processor 616 may include one or more processors capable of being programmed to perform one or more operations or processes described elsewhere herein.

The memory 618 may include volatile and/or nonvolatile memory. For example, the memory 618 may include random access memory (RAM), read only memory (ROM), and/or another type of memory (e.g., a flash memory, a magnetic memory, and/or an optical memory). The memory 618 may be a non-transitory computer-readable medium. The memory 618 may store information (i.e., data), one or more instructions, and/or software (e.g., one or more software applications) related to the operation of the system 600. Communicative coupling between the processor 616 and a memory 618 may enable the processor 616 to read and/or process the data (e.g., computing instructions, software, and/or the like) stored in the memory 618 and/or to store information in the memory 618.

The input/output component 620 may enable the BMM 614 to receive input, such as user input and/or sensed input from the sensors 612. The input/output component 620 may enable the BMM 614 to provide output, such as via a display, a speaker, and/or a light-emitting diode (e.g., a light-emitting diode that indicates and displays a charging level of the battery). The BMM 614 may communicate with other devices (e.g., the battery pack 602, an electrical device 624, and/or the like) via a wired connection and/or a wireless connection. For example, the BMM 618 may communicate with the battery pack 602 and/or the electrical device 624 by way of a receiver, a transmitter, a transceiver, and/or the like.

The BMM 618 may perform one or more operations or processes described herein. For example, a non-transitory computer-readable medium (i.e., memory 618) may store a set of instructions (e.g., one or more instructions or computing code) for execution by the processor 616. The processor 616 may execute the set of instructions to perform one or more operations or processes described herein. In some implementations, execution of the set of instructions, by one or more processors 616, causes the one or more processors 616 and/or the BMM 614 to perform one or more operations or processes described herein (e.g., control the pump, control the cooling device, control the battery pack, control the charging/discharging circuitry, and/or the like). In some implementations, hardwired circuitry may be used instead of or in combination with the instructions to perform one or more operations or processes described herein. Additionally, or alternatively, the processor 616 may be configured to perform one or more operations or processes described herein. Thus, implementations described herein are not limited to any specific combination of hardware circuitry and software.

In some implementations, the system 600 is connected to the electrical device 624 via a wired or wireless connection. The electrical device 624 may include a charging device or s charger or a device that operates by way of power supplied by the battery pack 602. In some implementations, the electrical device 624 includes an EV, such as an electrical car, truck, motorcycle, go-cart, golf cart, toy vehicle, riding lawnmower, and/or the like. The BMM 614 may control the rate at which the battery pack 602 charges and discharges via the charging/discharging circuitry 622 and s a battery pack controller. In some implementations, the battery pack 602 is charging and/or discharging simultaneously with the fluid pumping through the inlet and the outlet, so that the battery pack 602 may be cooled during charging and/or discharging.

The number and arrangement of components shown in FIG. 7B are provided as an example. The BMM 614, the battery pack 602, and the electrical device 624 may include additional components, fewer components, different components, or differently arranged components than those shown in FIG. 7B. FIGS. 7A and 7B are provided as examples only. Other examples may differ from what is described with regard to FIGS. 7A and 7B.

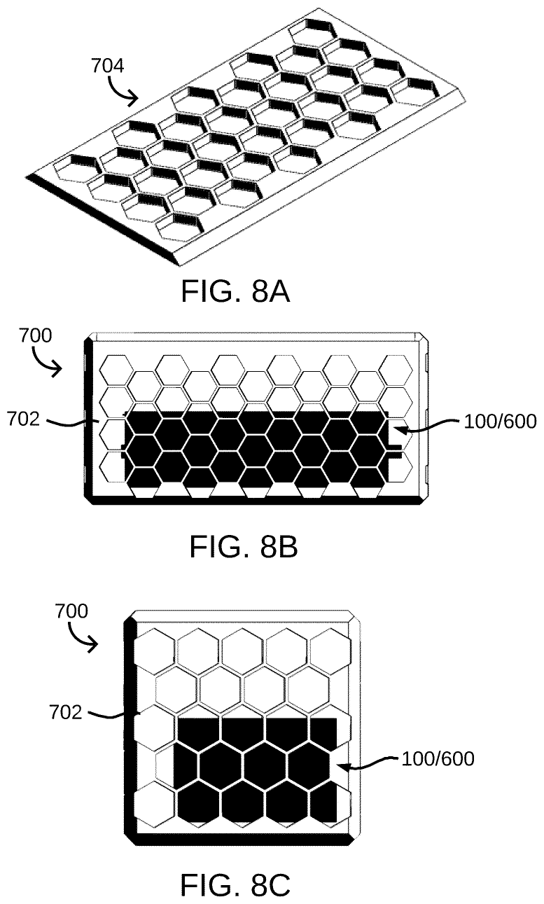

FIGS. 8A to 8C are diagrams illustrating a further example battery pack system 700 having improved thermal management. Referring collectively to FIGS. 8A-8C, the battery pack system 700 may include a protective housing 702 and the battery pack 100 and/or the battery system 600 described herein. The protective housing 702 may be constructed from one or more panels 704. The panels 704 may comprise a tough, impact resistant material such as an impact resistant plastic. The panels 704 may further comprise a plurality of interconnected honeycomb structures exhibiting an improved toughness and improved mechanical properties. The honeycomb structures may be hollow, or at least partially hollow, structures that contribute to and/or allow additional cooling per battery pack. For example, the housing 702 may allow air to flow over and around the battery pack 100 disposed therein and minimize any trapping of heat. In some implementations, the housing 702 is configured to cover, seal, and otherwise protect the battery pack 100 and/or system 600 disposed therein.

FIGS. 8A to 8C are provided as examples. Other examples may differ from what is described with regard to FIGS. 8A to 8C.

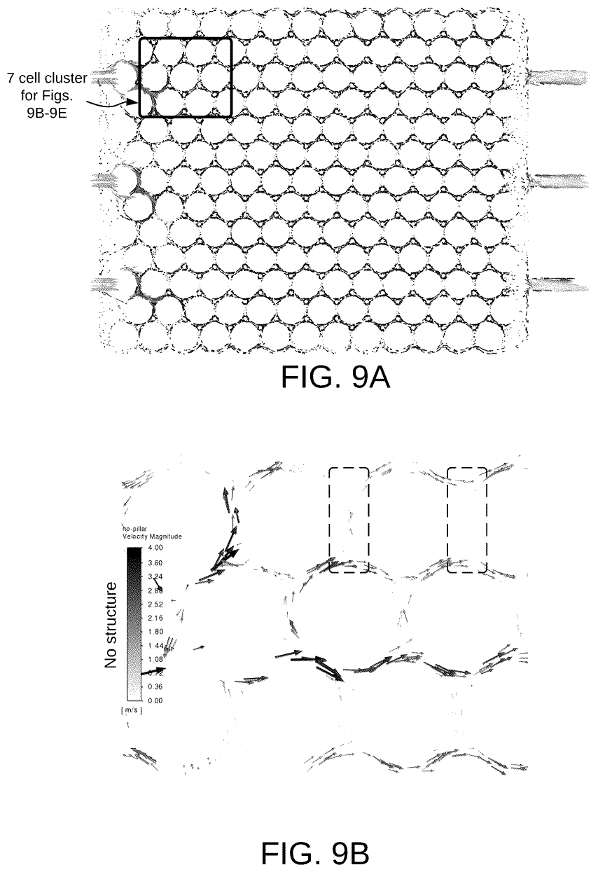

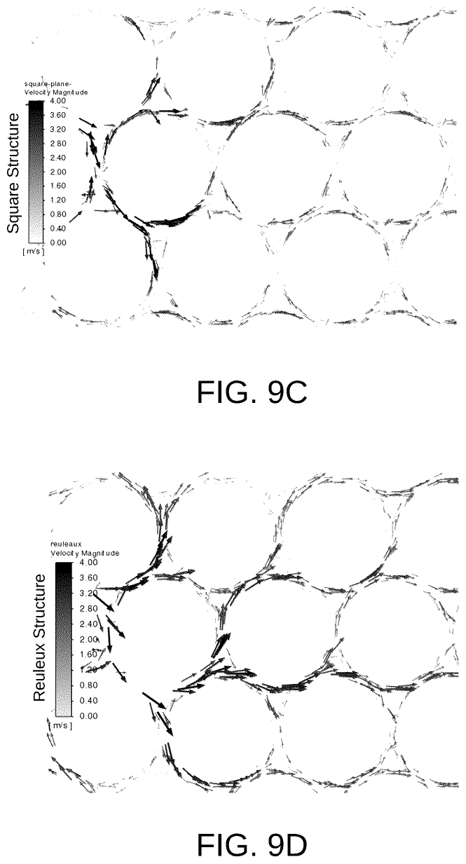

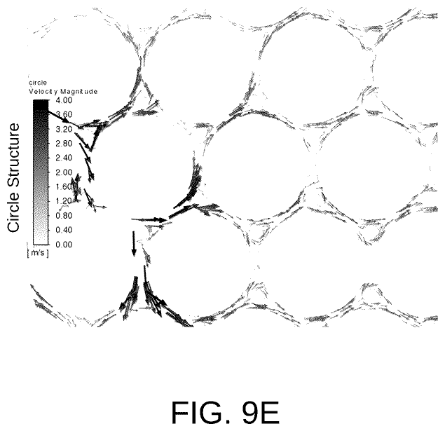

FIGS. 9A-9E are diagrams illustrating example immersion fluid velocity and flow data associated with battery packs and battery pack systems having improved thermal management and cooling. FIG. 9A is for reference only and depicts a location of a cluster of battery cells in a battery pack. The data obtained in FIGS. 9B-9E are obtained from clusters of cells at similar locations within a battery pack.

FIG. 9B illustrates velocity data for a battery pack that is devoid of structures positioned within gaps between adjacent cells, while FIGS. 9C-9E illustrate velocity data for a battery pack containing various, differently shaped pillars or structures in the gaps between adjacent battery cells. As the data indicates, placing structures in gaps between the battery cells of a battery pack slows the velocity of the fluid moving through the gaps and through the cluster of battery cells, which advantageously provides better dispersion of the immersion fluid in the battery pack, and, thus, more fully immerses the battery cells in the battery pack. In this way, battery packs having structures positioned in the spaces between the battery cells allows more heat to be transported out of the battery pack.

Referring to FIG. 9B, an immersion fluid is shown as advancing quickly through the battery pack at higher velocities and fails to adequately flow against all surfaces of the battery cells disposed in the pack. For example, some spaces between the cells have little to no immersion fluid flowing between adjacent cells in the pack (see e.g., spaces marked in broken line boxes). The immersion fluid flows quickly through the gaps and fails to fully immerse the battery cells. In this way, the battery pack may exhibit hot spots and/or poor thermal management.

FIG. 9C illustrates the velocity and flow of an immersion fluid moving through a battery pack including structures having square cross-sectional shapes disposed in gaps between the battery cells. As FIG. 9C illustrates, the fluid is better dispersed and spread in the battery pack, specifically in gaps between adjacent battery cells in the battery pack. The fluid slows by about 0.5 to 2 m/s upon contacting the square structures and moving through the gaps and through the many rows of adjacent battery cells.

FIG. 9D illustrates the velocity and flow of an immersion fluid moving through a battery pack including structures having triangular cross-sectional shapes (i.e., specifically Reuleaux triangle shapes) disposed in gaps between the battery cells. As this figure illustrates, the fluid is better dispersed in the battery pack, specifically between adjacent battery cells in the battery pack. The fluid slows as it contacts the structures and moves through the gaps and through the many rows of adjacent battery cells.

FIG. 9E illustrates the velocity and flow of an immersion fluid moving through a battery pack including structures having circular cross-sectional shapes disposed in gaps between the battery cells. As this figure illustrates, the fluid is better dispersed in the battery pack. The fluid slows to between about 0.08 m/s and 1.2 m/s as it moves through the gaps and through the many rows of adjacent battery cells.

FIGS. 9A-9E are provided as examples. Other examples may differ from what is described with regard to FIGS. 9A-9E.

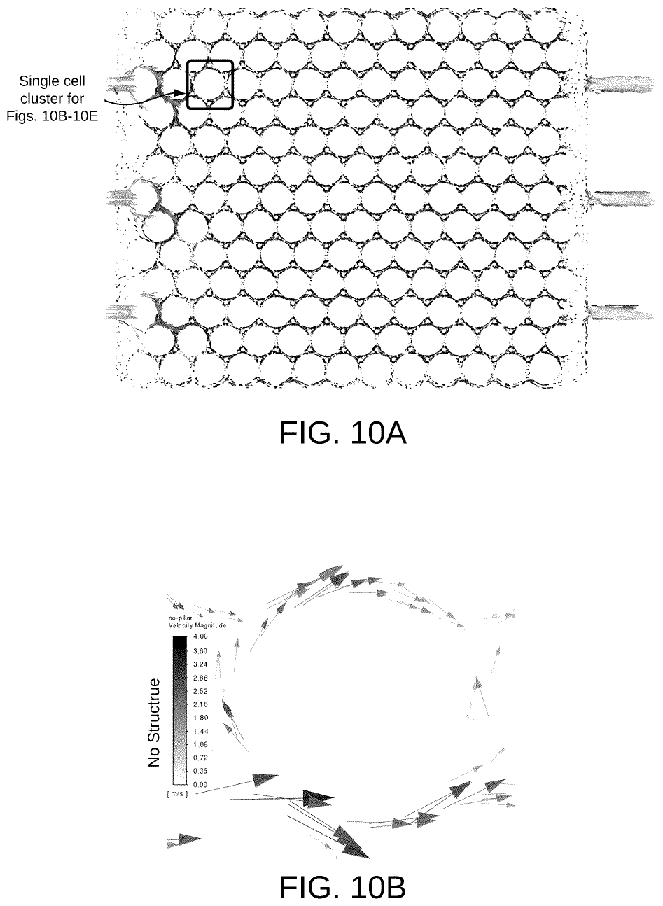

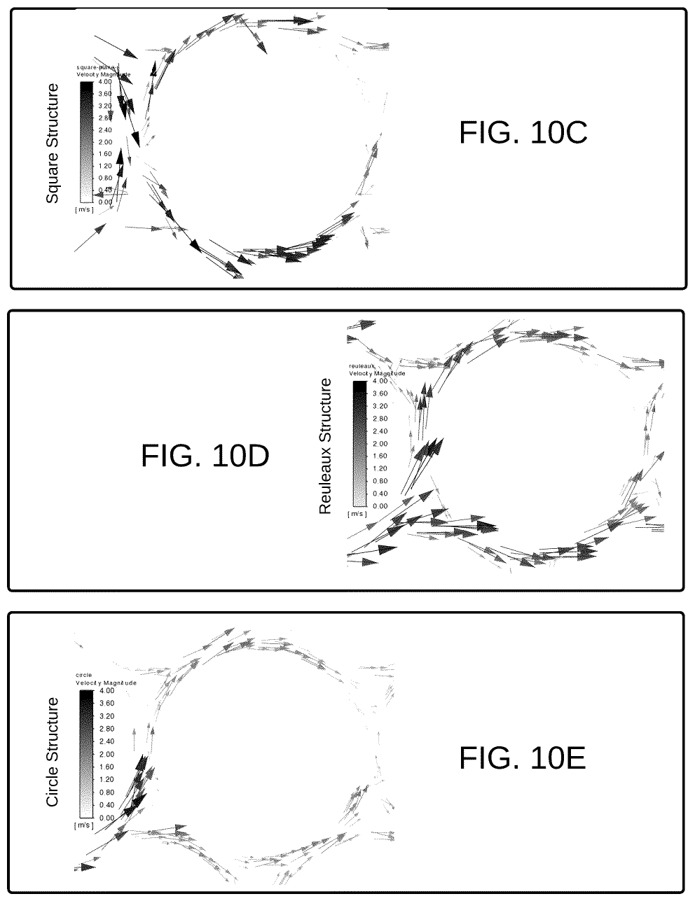

FIGS. 10A-10E are diagrams illustrating example fluid velocity and flow data associated with battery packs and battery pack systems having improved thermal management and cooling. FIG. 10A is for reference only and depicts a location of a battery cell in a battery pack. The data obtained in FIGS. 10B-10E are obtained from battery cells at a similar location within a battery pack. FIG. 10B illustrates data for a battery pack that is devoid of structures positioned within gaps between adjacent cells, while FIGS. 10C-10E illustrate data for a battery pack containing various, differently shaped structures in the gaps between adjacent battery cells. As the data indicates, use of structures in a battery pack provides better dispersion of the immersion fluid in the battery pack.

Referring to FIG. 10B, an immersion fluid is shown as advancing through the battery pack. The lack of structures in the battery pack fails to adequately guide the fluid against an outer surface of a battery cell disposed in the battery pack. For example, the space to the right of the battery cell in FIG. 10B has little to no immersion fluid present. Moreover, as the fluid contacts and bombards the battery cell, the fluid is guided away from the outer surface of the battery cell. As FIGS. 10C-10E illustrate, the structures improve advancement of the fluid towards the battery cells to improve contact with the battery cells.

FIG. 10C illustrates the velocity and flow data for an immersion fluid moving through a battery pack including square shaped structures provided therein. As FIG. 10C illustrates, the structures facilitate improved aim or guidance of fluid around the perimeter of a battery cell in the battery pack.

FIG. 10D illustrates the velocity and flow of an immersion fluid moving through a battery pack including triangular structures (i.e., specifically Reuleaux triangle shapes). As this figure illustrates, the fluid makes better contact with a battery cell in the battery pack, specifically by way of the fluid being guided around the perimeter of the battery cell.

FIG. 10E illustrates the velocity and flow of an immersion fluid moving through a battery pack including circular shaped structures disposed around a battery cell. As FIG. 10E illustrates, the wetting of the battery cell is improved.

FIGS. 10A-10E are provided as examples. Other examples may differ from what is described with regard to FIGS. 10A-10E.

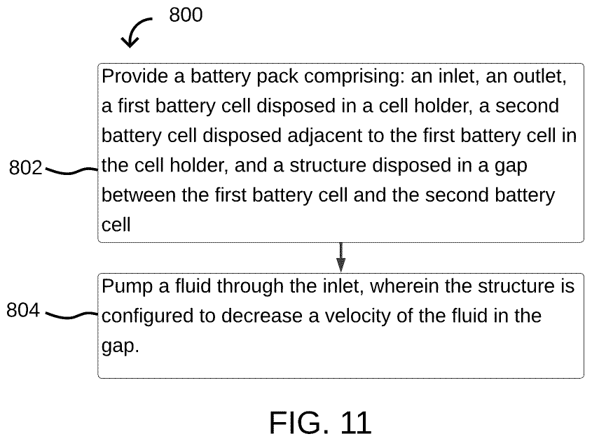

FIG. 11 is a flowchart illustrating an example method 800 of improving thermal management in the battery packs and battery pack systems described herein. In some implementations, one or more process blocks of FIG. 11 may be performed by a battery pack or battery pack system component (e.g., the pump 604, the manifold 606, the BMM 614, the charging/discharging circuitry 622, and/or the like).

The method 800 includes providing a battery pack (block 802). The provided battery pack comprises an inlet, an outlet, a first battery cell disposed in a cell holder, a second battery cell disposed adjacent to the first battery cell in the cell holder, and a structure disposed in a gap between the first battery cell and the second battery cell.

The method 800 may further include pumping a fluid through the inlet (block 804). The structure is configured to decrease a velocity of the fluid in the gap.

FIG. 11 is provided as an example. Other examples may differ from what is described with regard to FIG. 11.

Some implementations described herein relate to a battery pack. The battery pack may include a cell holder, an inlet disposed proximate to a first end of the cell holder, an outlet disposed proximate to a second end of the cell holder, and a fluid flowing between the inlet and the outlet. A first battery cell and a second battery cell may be disposed in the cell holder. A structure may be disposed in a gap between the first battery cell and the second battery cell. The structure may be configured to direct the fluid towards a first circumferential edge of the first battery cell and a second circumferential edge of the second battery cell.

In some implementations, the structure is a columnar or pillar-like structure projecting from a surface of the cell holder. In some implementations, the structure is a mesh structure. In some implementations, the structure includes a length, and a thickness of the structure varies along the length. The structure may include one of a triangular cross-section, a square cross-section, a circular cross-section, and a hexagonal cross-section. Structures having any regular or irregular and any symmetrical or asymmetrical sectional shape are contemplated.

In some implementations, the inlet and the outlet are formed in opposing sidewalls of the cell holder and an inlet axis is aligned with an outlet axis. In some implementations, the fluid includes a thermal conductivity that is greater than 0.05 W/mK at 20° C. The battery packs may include a row of five or more battery cells. A first battery cell and a second battery cell are provided in the row, and three or more structures are disposed around a majority of the five or more battery cells in the row. In some implementations, three or more structures are disposed around each of the five or more battery cells in the row.

Some implementations described herein relate to a battery system. The battery system may include a battery pack, a pump, and a housing configured to house the battery pack and the pump. The battery pack may include a cell holder, a plurality of battery cells disposed in the cell holder, and a plurality of structures disposed in the cell holder. A structure, of the plurality of structures, may be disposed in a gap between adjacent battery cells in the plurality of battery cells, and the structure is configured to decrease a velocity of a fluid in the gap.

In some implementations, each structure in the plurality of structures is disposed between at least three battery cells in the plurality of battery cells. In some implementations, the plurality of battery cells and the plurality of structures are each arranged in a straight line. In some implementations, the plurality of battery cells and the plurality of structures are each arranged in a zigzag pattern in which battery cells in the plurality of battery cells and structures in the plurality of structures alternate above and below a straight line. In some implementations, the battery cells in the plurality of battery cells are rechargeable lithium-ion battery cells. In some implementations, the system further includes a manifold connected to the pump, wherein the manifold is disposed outside of the battery pack for recirculating the fluid between the one or more outlets and the one or more inlets.

Some implementations described herein relate to a method of improving thermal management in a battery pack or system. The method may include providing a battery pack, the battery pack may include an inlet, an outlet, a first battery cell disposed in a cell holder, a second battery cell disposed adjacent to the first battery cell in the cell holder, and a structure disposed in a gap between the first battery cell and the second battery cell. The method may additionally include pumping a fluid through the inlet of the cell holder. The structure is configured to decrease a velocity of the fluid.

In some implementations, the method further comprises pumping the fluid through the outlet and circulating the fluid through a manifold to move the fluid from the outlet to the inlet. In some implementations, the method further comprises cooling the fluid as it circulates through the manifold. In some implementations, the method further comprises charging the first battery cell and the second battery cell as the fluid is pumping through the inlet and the outlet.

The foregoing disclosure provides illustration and description but is not intended to be exhaustive or to limit implementations to the precise forms disclosed. Modifications and variations may be made in light of the above disclosure or may be acquired from practice of the implementations described herein.

The orientations of the various elements in the figures are shown as examples, and the illustrated examples may be rotated relative to the depicted orientations. The descriptions provided herein, and the claims that follow, pertain to any structures that have the described relationships between various features, regardless of whether the structures are in the particular orientation of the drawings, or are rotated relative to such orientation. Similarly, spatially relative terms, such as “below,” “beneath,” “lower,” “above,” “top”, “bottom”, “upper,” “middle,” “left,” and “right,” are used herein for ease of description to describe one element's relationship to one or more other elements as illustrated in the figures. The spatially relative terms are intended to encompass different orientations of the element, structure, and/or assembly in use or operation in addition to the orientations depicted in the figures. A structure and/or assembly may be otherwise oriented (rotated 90 degrees or at other orientations), and the spatially relative descriptors used herein may be interpreted accordingly. Furthermore, the cross-sectional views in the figures only show features within the planes of the cross-sections, and do not show materials behind the planes of the cross-sections, unless indicated otherwise, in order to simplify the drawings.

As used herein, the terms “substantially,” “about,” and “approximately” mean “within reasonable tolerances of manufacturing and measurement.”

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a module” or “one or more modules”) is described or claimed (within a single claim or across multiple claims) as performing multiple operations or being configured to perform multiple operations, this language is intended to broadly cover a variety of environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” may be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A battery pack, comprising:
a cell holder;
an inlet disposed proximate to a first end of the cell holder;
an outlet disposed proximate to a second end of the cell holder;
a fluid flowing between the inlet and the outlet;
a first battery cell disposed in the cell holder;
a second battery cell disposed adjacent to the first battery cell in the cell holder; and
a structure disposed in a gap between the first battery cell and the second battery cell,
wherein the structure is configured to direct the fluid towards a first circumferential edge of the first battery cell and a second circumferential edge of the second battery cell.

2. The battery pack of claim 1, wherein the structure is a columnar structure projecting from a surface of the cell holder.

3. The battery pack of claim 1, wherein the structure is a mesh structure.

4. The battery pack of claim 1, wherein the structure comprises a length, and
wherein a thickness of the structure varies along the length.

5. The battery pack of claim 1, wherein the structure comprises one of:
a triangular cross-section;
a square cross-section;
a circular cross-section; and
a hexagonal cross-section.

6. The battery pack of claim 1, wherein the inlet and the outlet are formed in opposing sidewalls of the cell holder, and
wherein an inlet axis is aligned with an outlet axis.

7. The battery pack of claim 6, wherein the fluid comprises a thermal conductivity that is greater than 0.05 W/mk at 20° C.

8. The battery pack of claim 1, further comprising a row of five or more battery cells,
wherein the first battery cell and the second battery cell are provided in the row, and
wherein three or more structures are disposed around a majority of the five or more battery cells in the row.

9. The battery pack of claim 8, wherein three or more structures are disposed around each of the five or more battery cells in the row.

10. A battery system, comprising:
a battery pack, comprising:
a cell holder;
a plurality of battery cells disposed in the cell holder; and
a plurality of structures disposed in the cell holder,
wherein a structure in the plurality of structures is disposed in a gap between adjacent battery cells in the plurality of battery cells, and
wherein the structure is configured to decrease a velocity of a fluid in the gap;
a pump configured to pump the fluid through the battery pack; and
a housing configured to house the battery pack and the pump.

11. The system of claim 10, wherein each structure in the plurality of structures is disposed between at least three battery cells in the plurality of battery cells.

12. The system of claim 11, wherein the plurality of battery cells and the plurality of structures are each arranged in a straight line.

13. The system of claim 11, wherein the plurality of battery cells and the plurality of structures are each arranged in a zigzag pattern in which battery cells in the plurality of battery cells and structures in the plurality of structures alternate above and below a straight line.

14. The system of claim 10, wherein each structure in the plurality of structures comprises one of:
a triangular cross-section;
a square cross-section;
a circular cross-section; and
a hexagonal cross-section.

15. The system of claim 10, wherein battery cells in the plurality of battery cells are rechargeable lithium-ion battery cells.

16. The system of claim 10, further comprising a manifold connected to the pump, wherein the manifold is disposed outside of the battery pack for recirculating the fluid between the one or more outlets and the one or more inlets.

17. A method of improving thermal management in a battery system, the method comprising:
providing a battery pack, the battery pack comprising:
an inlet;
an outlet;
a first battery cell disposed in a cell holder;
a second battery cell disposed adjacent to the first battery cell in the cell holder; and
a structure disposed in a gap between the first battery cell and the second battery cell; and
pumping a fluid through the inlet of the cell holder,
wherein the structure is configured to decrease a velocity of the fluid.

18. The method of claim 17, further comprising:
pumping the fluid through the outlet; and
circulating the fluid through a manifold to move the fluid from the outlet to the inlet.

19. The method of claim 18, further comprising:
cooling the fluid circulating through the manifold.

20. The method of claim 18, further comprising:
charging the first battery cell and the second battery cell as the fluid is pumping through the inlet and the outlet.
